(19) United States
(12) Patent Application Publication
(10) Pub. No.: US 2023/0182085 A1
(43) Pub. Date: Jun. 15, 2023

(54) POROUS MEMBRANE LAMINATE, FILTER ELEMENT AND METHOD OF MANUFACTURING POROUS MEMBRANE LAMINATE

(71) Applicants: SUMITOMO ELECTRIC FINE POLYMER, INC., Osaka (JP); SUMITOMO ELECTRIC INDUSTRIES, LTD., Osaka (JP)

(72) Inventors: Mitsuhiro AKAMA, Osaka (JP); Yoshimasa SUZUKI, Osaka (JP); Fumihiro HAYASHI, Osaka (JP); Takamasa HASHIMOTO, Osaka (JP); Hirokazu KATAYAMA, Osaka (JP)

(21) Appl. No.: 17/924,564

(22) PCT Filed: Apr. 5, 2021
(86) PCT No.: PCT/JP2021/014445

§ 371 Date: Nov. 10, 2022

(30) Foreign Application Priority Data
May 22, 2020 (JP) 2020-089970

(51) Int. Cl. B01D 69/12; B01D 69/02; B01D 69/10; B01D 71/36; B01D 67/00

(52) U.S. Cl. CPC B01D 69/1213; B01D 69/02; B01D 69/105; B01D 69/107; B01D 71/36; B01D 67/0027; B01D 67/003; B01D 2325/02833; B01D 2325/04; B01D 2323/28; B01D 2323/64; B01D 2325/0212

(57) ABSTRACT

A porous membrane laminate of the present disclosure includes a porous support layer and a porous membrane laminated on one surface of the support layer and containing polytetrafluoroethylene as a main component. The porous membrane is formed of a uniaxially stretched material, the porous membrane has a mean pore size of 25 nm to 35 nm and a maximum pore size of 49 nm or less, and the porous membrane has an average thickness of 0.6 μm to 3.5 μm.

### TECHNICAL FIELD

The present disclosure relates to a porous membrane laminate, a filter element and a method of manufacturing porous membrane laminates. This application claims priority based on Japanese Patent Application No. 2020-089970 filed on May 22, 2020, and the entire contents of the Japanese patent application are incorporated herein by reference.

### BACKGROUND ART

A porous filter using polytetrafluoroethylene (PTFE) has characteristics such as high heat resistance, chemical stability, weather resistance, incombustibility, high strength, non-adhesiveness, and a low friction coefficient of PTFE, and characteristics such as flexibility, dispersion medium permeability, particle capturing properties, and a low dielectric constant due to porosity. Therefore, porous filters made of PTFE are widely used as microfiltration filters for dispersion media and gases in semiconductor-related fields, liquid-crystal-related fields, and food-medical-related fields. As such a filter, a porous filter using a porous sheet made of PTFE capable of capturing fine particles having a particle diameter of less than 0.1 μm has been proposed in recent years (see Japanese Unexamined Patent Application Publication No. 2010-94579).

### PRIOR ART DOCUMENT

### Patent Literature

[Patent Document 1] Japanese Unexamined Patent Application Publication No. 2010-94579

### SUMMARY OF INVENTION

A porous membrane laminate according to an aspect of the present disclosure includes a porous support layer, and a porous membrane laminated on one surface of the support layer and containing polytetrafluoroethylene as a main component. The porous membrane is formed of a uniaxially stretched material, the porous membrane has a mean pore size of 25 nm to 35 nm and a maximum pore size of 49 nm or less, and the porous membrane has an average thickness of 0.6 μm to 3.5 μm.

A method of manufacturing a porous membrane laminate according to another aspect of the present disclosure is a method of manufacturing a porous membrane laminate including a porous support layer and a porous membrane laminated on one surface of the support layer, the method includes, applying a porous membrane-forming composition containing polytetrafluoroethylene as a main component to a surface of a metal foil, sintering the porous membrane-forming composition applied in the application, laminating, on one surface of the support layer, a nonporous membrane formed after the sintering, removing the metal foil from a nonporous membrane laminate formed in the lamination, selecting, among nonporous membrane laminates after the removal, a nonporous membrane laminate having a pressure resistance to a fluorine-based solvent of 101.325 kPa or more, and uniaxially stretching, at room temperature, the nonporous membrane laminate selected by the selection. The fluorine-based solvent has a boiling point of 130° C. or lower and a surface tension of 15 mN/m or less, and a porous membrane of a porous membrane laminate formed after the uniaxial stretching has an average thickness of 0.6 μm to 3.5 μm and a maximum pore size of 49 nm or less.

### BRIEF DESCRIPTION OF DRAWINGS

FIG. 1 is a schematic fragmentary sectional view of a porous membrane laminate according to an embodiment of the present disclosure.

### DESCRIPTION OF EMBODIMENTS

### Problems to be Solved by Present Disclosure

In the above-mentioned fields, there is a demand for higher performance microfiltration filters due to further technical innovation and increased requirements.

The present disclosure has been made in view of such circumstances, and an object of the present disclosure is to provide a porous membrane laminate excellent in fine particle capturing performance and filtration efficiency.

### Advantageous Effects of Present Disclosure

The porous membrane laminate according to one aspect of the present disclosure is excellent in fine particle capturing performance and filtration efficiency.

### Description of Embodiments of Present Disclosure

First, embodiments of the present disclosure will be listed and described.

A porous membrane laminate according to an aspect of the present disclosure includes a porous support layer, and a porous membrane laminated on one surface of the support layer and containing polytetrafluoroethylene as a main component. The porous membrane is formed of a uniaxially stretched material, the porous membrane has a mean pore size of 25 nm to 35 nm and a maximum pore size of 49 nm or less, and the porous membrane has an average thickness of 0.6 μm to 3.5 μm.

The porous membrane laminate includes a porous membrane which is a uniaxially stretched material containing polytetrafluoroethylene (hereinafter also referred to as “PTFE”) as a main component. When the mean pore size, the maximum pore size, and the average thickness of the porous membrane per 623.7 cm² in plan view are within the above ranges, the porous membrane has excellent fine particle capturing performance and filtration efficiency. The term “main component” refers to a component having the largest content in terms of mass, for example, a component having a content of 50% by mass or more, preferably 70% by mass or more, and more preferably 90% by mass or more. The “mean pore size” means an average size of pores on the outer surface of the support layer, and may be measured by a pore size distribution measuring device (for example, a perm porometer “CFP-1200A” manufactured by PMI Co., Ltd.). “Average thickness” refers to an average value of thicknesses at arbitrary 10 points.

It is preferable that the porous membrane laminate has an isopropanol bubble point of 600 kPa or more. When the isopropanol bubble point of the porous membrane laminate is within the above range, the porous membrane laminate can further improve the fine particle capturing performance. Here, the “isopropanol bubble point” is a value measured in accordance with ASTM-F316-86 using isopropyl alcohol, indicates a minimum force required to push out the dispersion medium from the pores, and is an indicator corresponding to the mean pore size.

It is preferable that the porous membrane laminate has an area of 623.7 cm² or more in plan view. According to this embodiment, since the mean pore size is from 25 nm to 35 nm and the maximum pore size is 49 nm or less in the region of 623.7 cm² or more of the area of the porous membrane, the fine particle capturing performance and the filtration efficiency are excellent in a wide region.

In the conventional porous membrane laminate, the mean pore size is from 25 nm to 35 nm, and the maximum pore size is 49 nm or less, but areas of 623.7 cm² or more cannot be secured. In other words, the area of the region having excellent capturing performance and filtration efficiency was very small.
The porous membrane laminate of the present disclosure has a surface having a mean pore size of 25 nm to 35 nm and a maximum pore size of 49 nm or less, and has an area of 623.7 cm² or more. Therefore, the porous membrane laminate is excellent in fine particle capturing performance and filtration efficiency in a wide range.

Another aspect of the present disclosure is a filter element including the porous membrane laminate. Since the porous membrane laminate is used for the filter element, it is possible to provide a microfiltration filter having excellent fine particle capturing performance and filtration efficiency.

A method of manufacturing a porous membrane laminate according to another aspect of the present disclosure is a method of manufacturing a porous membrane laminate according to another aspect of the present disclosure is a method of manufacturing a porous membrane laminate including a porous support layer and a porous membrane laminated on one surface of the support layer, the method includes applying a porous membrane-forming composition containing polytetrafluoroethylene as a main component to a surface of a metal foil, sintering the porous membrane-forming composition applied in the application, laminating, on one surface of the support layer, a nonporous membrane formed after the sintering, removing the metal foil from a nonporous membrane laminate formed in the lamination, selecting, among nonporous membrane laminates after the removal, a nonporous membrane laminate having a pressure resistance to a fluorine-based solvent of 101.325 kPa or more and uniaxially stretching, at room temperature, the nonporous membrane laminate selected by the selection. The fluorine-based solvent has a boiling point of 130° C. or lower and a surface tension of 15 mN/m or less, and a porous membrane of a porous membrane laminate formed after the uniaxial stretching has an average thickness of 0.6 μm to 3.5 μm and a maximum pore size of 49 nm or less.

When the thickness of the film containing PTFE as the main component is very small, the elongation at break is small and stretching becomes very difficult. In particular, when defective holes such as pinholes are present in the nonporous membrane having PTFE as a main component before the stretching step for forming pores, it is very difficult to control the size of the pores of the porous membrane formed after the stretching step. On the other hand, since a porous membrane containing PTFE as a main component is transparent, it is difficult to detect defective holes, and a defect detection limit diameter is about 30 μm in a general defect inspection apparatus using transmitted light. However, defective holes such as pinholes may be easily detected with high accuracy by including, in the method of manufacturing a porous membrane laminate, a step of selecting a nonporous membrane laminate by using pressure resistance evaluation to a fluorine-based solvent having a boiling point of 130° C. or lower and a surface tension of 15 mN/m or less before stretching a nonporous membrane made of PTFE. As a result, the mean pore size and the maximum pore size of the pores formed by the uniaxially stretching process to be in a good range. In addition, by setting the average thickness of the porous membrane of the porous membrane laminate formed after the uniaxially stretching step to 0.6 μm to 3.5 μm and setting the maximum pore size to 49 nm or less, it is possible to improve the effectiveness and accuracy of the filtration treatment of the porous membrane laminate. Therefore, the method of manufacturing a porous membrane laminate may easily and reliably manufacture a porous membrane laminate excellent in fine particle capturing performance and filtration efficiency.

It is preferable that the nonporous membrane of the nonporous membrane laminate selected by the selection includes a defective hole, and the defective hole has a maximum pore size of 600 nm or less. When the maximum pore size of the defective holes of the nonporous membrane of the nonporous membrane laminate selected in the selecting step is 600 nm or less, the mean pore size and the maximum pore size of the pores formed after the process of uniaxially stretching the nonporous membrane may be controlled to be in a good range. When the maximum pore size of the defective holes of the nonporous membrane of the nonporous membrane laminate exceeds 600 nm, pores having a pore size of 50 nm or more are likely to be scattered in an infinite number after the step of uniaxially stretching, and thus there is a concern that it is difficult to control the pore size.

It is preferable that the nonporous membrane of the nonporous membrane laminate selected by the selection does not include a defective hole. Since the nonporous membrane of the nonporous membrane laminate selected by the selecting step does not include defective holes, the mean pore size and the maximum pore size of the pores formed after the uniaxially stretching step of the nonporous membrane may be controlled in a good range.

### Details of Embodiments of Present Disclosure

Hereinafter, preferred embodiments of the present disclosure will be described with reference to the drawings.

<Porous Membrane Laminate>

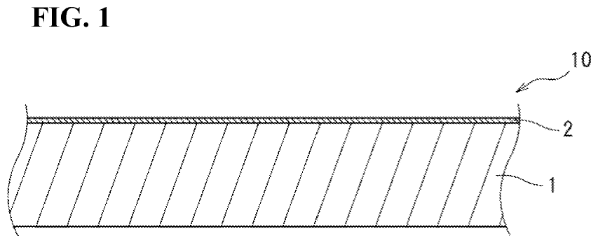

A porous membrane laminate 10 shown in FIG. 1 includes a porous support layer 1 and a porous membrane 2 laminated on one surface of support layer 1. In porous membrane laminate 10, since porous membrane 2 is laminated and supported on one surface of support layer 1, strength may be improved. In addition, porous membrane laminate 10 may be applied as a filter element.

[Porous Membrane]

Porous membrane 2 has polytetrafluoroethylene (PTFE) as a main component. Porous membrane 2 allows a filtrate to permeate in a thickness direction while preventing permeation of fine impurities.

Porous membrane 2 is a uniaxially stretched material. The uniaxially stretched material refers to a material that has been uniaxially stretched. The term “uniaxially stretch” refers to stretching in only one direction, and porous membrane 2 is transversely stretched in a transverse direction (the axial direction of a rolling roll perpendicular to the longitudinal direction (conveyance direction)).

A heat of fusion of PTFE which is the main component of porous membrane 2 is preferably from 25 J/g to 29 J/g. When the heat of fusion of PTFE is in the above range, the range of the mean pore size of porous membrane 2 may be easily controlled to a favorable range.

A lower limit of the mean pore size per 623.7 cm² in plan view in porous membrane 2 is 25 nm. On the other hand, an upper limit of the mean pore size is 35 nm, and preferably 30 nm. When the mean pore size of porous membrane 2 is less than the lower limit, the pressure loss of the porous membrane laminate may increase. On the other hand, when the mean pore size of porous membrane 2 exceeds the above upper limit, the fine particle capturing performance of the porous membrane laminate may be insufficient.

An upper limit of the maximum pore size per 623.7 cm² in plan view in porous membrane 2 is 49 nm, and 46 nm is preferable. When the maximum pore size of porous membrane 2 exceeds the above upper limit, the fine particle capturing performance of the porous membrane laminate may be insufficient. When the mean pore size and the maximum pore size of porous membrane 2 are in the above-described ranges, the porous membrane laminate is excellent in fine particle capturing performance and filtration efficiency.

A lower limit of the average thickness of porous membrane 2 is 0.6 μm. On the other hand, an upper limit of the average thickness of porous membrane 2 is 3.5 μm, and preferably 3.0 μm. When the average thickness is less than the lower limit, the strength of porous membrane 2 may be insufficient. On the other hand, when the average thickness exceeds the upper limit, porous membrane 2 becomes unnecessarily thick, and there is a possibility that the pressure loss at the time of permeation of the filtrate increases. When the average thickness of porous membrane 2 is within the above range, both the strength and the filtration efficiency of porous membrane 2 may be achieved.

An upper limit of the porosity of porous membrane 2 is preferably 90%, and more preferably 85%. On the other hand, a lower limit of the porosity of porous membrane 2 is preferably 70%, and more preferably 75%. When the porosity of porous membrane 2 exceeds the upper limit, there is a possibility that the fine particle capturing performance in the porous membrane laminate becomes insufficient. On the other hand, when the porosity of porous membrane 2 is less than the lower limit, the pressure loss of the porous membrane laminate may increase. “Porosity” refers to the ratio of the total volume of pores to the volume of an object, and may be determined by measuring the density of the object in accordance with ASTM-D792.

Porous membrane 2 may contain, in addition to PTFE, other fluororesins and additives as long as the desired effects of the present disclosure are not impaired.

[Support Layer]

A material used for porous support layer 1 is not particularly limited as long as it is a porous material. Specific examples of support layer 1 include a foamed body, a nonwoven fabric, a stretched porous body, and the like, and examples of a material constituting these include a polyolefin-based resin such as polyethylene and polypropylene, a fluorine-based resin such as PTFE and PFA, a polyimide-based resin such as polyimide and polyamideimide, and the like.

A lower limit of the average thickness of support layer 1 is preferably 0.02 mm, and more preferably 0.03 mm. On the other hand, an upper limit of the average thickness of support layer 1 is preferably 0.06 mm, and more preferably 0.05 mm. Furthermore, from the viewpoint of achieving both the mechanical strength of support layer 1 and the filtration rate of porous membrane laminate 10, the average thickness is preferably from 0.020 mm to 0.040 mm, more preferably from 0.025 mm to 0.035 mm. When the average thickness is less than the lower limit, a mechanical strength of support layer 1 may be insufficient. On the other hand, when the average thickness exceeds the upper limit, porous membrane laminate 10 becomes unnecessarily thick, and there is a possibility that the pressure loss during permeation of the filtrate increases.

A lower limit of the mean pore size of support layer 1 is preferably 0.5 μm, and more preferably 1 μm.

On the other hand, an upper limit of the mean pore size is preferably 5 μm, and more preferably 3 μm. When the mean pore size of support layer 1 is less than the lower limit, the pressure loss of porous membrane laminate 10 may increase. On the other hand, when the mean pore size of porous membrane 2 exceeds the upper limit, the strength of support layer 1 may be insufficient.

Support layer 1 may contain other resins and additives as long as they do not adversely affect the desired effects of the present disclosure. Examples of the additives include pigments for coloring, inorganic fillers for improving abrasion resistance, preventing low-temperature flow, and facilitating pore formation, metal powders, metal oxide powders, and metal sulfide powders.

An upper limit of an average thickness of porous membrane laminate 10 is preferably 60 μm, and more preferably 50 μm. On the other hand, a lower limit of the average thickness of porous laminate 1 is preferably 20 μm, and more preferably 25 μm. When the average thickness of porous laminate 1 exceeds the upper limit, the pressure loss of porous membrane laminate 10 may increase. On the other hand, when the average thickness of porous laminate 1 is less than the lower limit, the strength of porous membrane laminate 10 may be insufficient.

An isopropanol bubble point of porous membrane laminate 10 is preferably from 600 kPa to 1310 kPa. When the isopropanol bubble point of porous membrane laminate 10 is less than the lower limit, the dispersion medium holding power of porous membrane laminate 10 may be insufficient. When the isopropanol bubble point of porous membrane laminate 10 exceeds the upper limit, there is a possibility that the gas permeability decreases and the degassing efficiency of porous membrane laminate 10 decreases. The isopropanol bubble point is preferably as close to the value in the mean pore size as possible. When the isopropanol bubble point of porous membrane laminate 10 is within the above range, porous membrane laminate 10 may further enhance the fine particle capturing performance.

Porous laminate 10 is excellent in fine particle capturing performance and filtration efficiency. Therefore, it is suitable for filters for microfiltration of dispersion media and gases used in applications such as cleaning, peeling, and supply of chemical solutions in semiconductor-related fields, liquid-crystal-related fields, and food-medical-related fields.

<Filter Element>

The porous membrane laminate described above is used as a filter element. Since the porous membrane laminate is used for the filter element, the filter element is excellent in fine particle capturing performance and filtration efficiency. In particular, it is suitable for purification of pure water for cleaning or stripping in semiconductor-related fields where precision is required.

<Method of Manufacturing Porous Membrane Laminate>

Next, an embodiment of the method of manufacturing the porous membrane laminate will be described. The method of manufacturing a porous membrane laminate is a method of manufacturing a porous membrane laminate including a porous support layer and a porous membrane laminated on one surface of the support layer. The method of manufacturing the porous membrane laminate includes applying a porous membrane-forming composition to a surface of a metal foil, sintering the porous membrane-forming composition, laminating, on one surface of the support layer, the formed porous membrane, removing the metal foil, selecting, among the nonporous membrane laminates after the removal, the nonporous membrane laminate having a pressure resistance to a fluorine-based solvent of 101.325 kPa or more, and uniaxially stretching, at room temperature, the porous membrane laminate.

[Step of Applying Porous Membrane-Forming Composition]

In this step, the porous membrane-forming composition containing polytetrafluoroethylene as a main component is applied to a surface of the metal foil. The surface of the metal foil is preferably smooth. The porous membrane-forming composition is a dispersion in which PTFE powder is dispersed in a dispersion medium. In this step, the dispersion medium is removed by drying after the porous membrane-forming composition is applied. As the dispersion medium, an aqueous medium such as water is usually used.

Examples of the metal of the metal foil include aluminum and nickel. Among these, aluminum is preferable from the viewpoints of flexibility, ease of removal, and ease of availability. The metal foil being smooth means that no pores or irregularities are observed on the surface of the metal foil on the side that comes into contact with the PTFE dispersion in this step. The thickness of the metal foil is not particularly limited, but it is desirable that the metal foil has such a thickness that the coating operation may be easily performed without introducing air bubbles into the coating film of the PTFE dispersion and that the metal foil is not difficult to be removed later.

The lower limit of the number average molecular weight of the PTFE powder forming porous membrane 2 is preferably 1,000,000, and more preferably 1,200,000. On the other hand, the upper limit of the number average molecular weight of the PTFE powder forming porous membrane 2 is preferably 5,000,000. When the number average molecular weight of the PTFE powder forming porous membrane 2 is less than the lower limit, the porosity and strength of porous membrane 2 may be insufficient. On the other hand, when the number average molecular weight of the PTFE powder forming the porous membrane exceeds the upper limit, it may be difficult to form the membrane. The “number average molecular weight” is a value measured by gel filtration chromatography.

The dispersion medium may be dried by heating to a temperature close to the boiling point of the dispersion medium or a temperature equal to or higher than the boiling point.

[Sintering Step]

In this step, the porous membrane-forming composition coated in the coating step is sintered. By this step, a nonporous membrane containing PTFE as a main component is formed. In this step, the coating film composed of the porous membrane-forming composition is heated to a temperature equal to or higher than the melting point of the fluororesin to be sintered, whereby a nonporous membrane of PTFE may be obtained. The drying of the dispersion medium and the heating for sintering may be performed in this step.

[Laminating Step]

In this step, the nonporous membrane formed after the sintering step is laminated on one surface of the support layer. A nonporous membrane laminate is formed by laminating the nonporous membrane on one surface of the support layer.

Examples of the method for fixing the nonporous membrane to the support layer include a bonding method using an adhesive or a pressure-sensitive adhesive, and a fusion bonding method by heating. The adhesive or pressure-sensitive adhesive is preferably a solvent-soluble or thermoplastic fluororesin or fluororubber from the viewpoints of heat resistance, chemical resistance, and the like.

[Step of Removing Metal Foil]

In this step, the metal foil is removed from the nonporous membrane laminate formed in the laminating step. Examples of the method for removing the metal foil include dissolution and removal with an acid or the like and mechanical peeling. When the removal of the metal foil is insufficient, a pinhole may be generated. Therefore, it is preferable to completely remove the metal foil by performing water washing after the removal of the metal foil. As described above, the nonporous membrane laminate may be obtained by applying a fluororesin dispersion obtained by dispersing PTFE powder in a dispersion medium onto a metal foil, and then drying and sintering the dispersion medium to remove the metal foil.

[Selecting Step]

In this step, a nonporous membrane laminate having a pressure resistance to a fluorine-based solvent of 101.325 kPa or more is selected among the nonporous membrane laminates after the removing step. That is, the nonporous membrane laminate may be selected by evaluating pressure resistance to a fluorine-based solvent. The above 101.325 kPa is a value of the atmosphere pressure.

The fluorine-based solvent is preferably a fluorine-based solvent which has low surface tension, viscosity and quick-drying properties and does not affect materials. In particular, such a fluorine-based solvent has a boiling point of 130° C. or lower and a surface tension of 15 mN/m or less. As such a fluorine-based solvent, for example, a fluorine-based solvent having a perfluorocarbon skeleton may be used. Examples of the trade name include Fluorinert (FC-3283) manufactured by 3M Co., Ltd.

Specifically, the pressure resistance of the nonporous membrane laminate to the fluorine-based solvent may be evaluated by the following procedure. First, a fluorine-based solvent is added dropwise to the nonporous membrane surface of the nonporous membrane laminate at room temperature under atmospheric pressure. When there are no defective holes such as pinholes in the nonporous membrane, the fluorine-based solvent is repelled by the nonporous membrane surface, and the fluorine-based solvent does not permeate into the nonporous membrane and the support layer of the nonporous membrane laminate. On the other hand, if a defective hole such as a pinhole is present in the nonporous membrane, when the fluorine-based solvent is dropped onto the nonporous membrane surface of the nonporous membrane laminate, the fluorine-based solvent immediately permeates into the support layer through the nonporous membrane surface. The permeation of the fluorine-based solvent may be visually determined from the surface of the support layer on the back side of the nonporous membrane laminate.

The nonporous membrane of the nonporous membrane laminate selected in the selecting step may not include a defective hole or may include a defective hole, but the maximum pore size of the defective hole is preferably 600 nm or less. When there is a hole having a maximum pore size exceeding the 600 nm in the nonporous membrane before uniaxially stretching, it is a defective hole generated in the manufacturing process. The maximum pore size may be measured by a general defect inspection apparatus using transmitted light. Therefore, by selecting the nonporous membrane of the nonporous membrane laminate to have the maximum pore size of 600 nm or less before the uniaxially stretching process, it is possible to control the mean pore size and the maximum pore size of the pores formed after the uniaxially stretching process of the nonporous membrane to be in a good range. When the maximum pore size of the nonporous membrane of the nonporous membrane laminate exceeds 600 nm, an infinite number of pores having a pore size of 50 nm or more are likely to be scattered after the step of uniaxially stretching, and thus there is a concern that it is difficult to control the pore size.

[Uniaxially Stretching Step]

In this step, the nonporous membrane laminate selected in the selecting step is uniaxially stretched at room temperature. By this step, pores are formed. The uniaxially stretch may be performed in multiple stages.

When the thickness of the film containing PTFE as the main component is very small, the elongation at break is small and stretching becomes very difficult. In particular, when defective holes such as pinholes are present in the nonporous membrane having PTFE as a main component before the stretching step for forming pores, it is very difficult to control the size of the pores of the porous membrane formed after the stretching step. On the other hand, since a porous membrane containing PTFE as a main component is transparent, it is difficult to detect defective holes, and a defect detection limit diameter is about 30 μm in a general defect inspection apparatus using transmitted light. However, defective holes such as pinholes may be easily detected with high accuracy by including, in the method of manufacturing a porous membrane laminate, a step of selecting a nonporous membrane laminate by using pressure resistance evaluation to a fluorine-based solvent having a boiling point of 130° C. or lower and a surface tension of 15 mN/m or less before stretching a nonporous membrane made of PTFE. As a result, the mean pore size and the maximum pore size of the pores formed by the uniaxially stretching process to be in a good range.

In this step, uniaxially stretch is performed at room temperature. By performing at room temperature, it is possible to improve the effect of suppressing the occurrence of breakage, pinholes, and the like due to uniaxially stretch. In addition, when the uniaxial stretching is performed in multiple stages, it is preferable to perform the uniaxial stretching at room temperature and then at a temperature of less than 30° C. When the stretching temperature is less than 30° C., the mean pore size of porous membrane 2 to be formed may be kept small.

As described above, the lower limit of the average thickness of porous membrane 2 of the manufactured porous membrane laminate is 0.6 μm. On the other hand, the upper limit of the average thickness of porous membrane 2 is 3.5 μm, and preferably 3.0 μm. When the average thickness is less than the lower limit, the strength of porous membrane 2 may be insufficient. On the other hand, when the average thickness exceeds the upper limit, porous membrane 2 becomes unnecessarily thick, and there is a possibility that the pressure loss at the time of permeation of the filtrate increases. When the average thickness of porous membrane 2 is in the above range, both the strength and the filtration efficiency of porous membrane 2 may be achieved.

Other configurations of the porous membrane and the support layer of the manufactured porous membrane laminate are the same as those described above, and thus redundant descriptions thereof will be omitted.

According to the method of manufacturing a porous membrane laminate, defective holes such as pinholes may be easily and accurately detected by providing a step of selecting a nonporous membrane laminate by using evaluation of pressure resistance to the fluorine-based solvent having the boiling point of 130° C. or less and a surface tension of 15 mN/m or less before stretching the nonporous membrane made of PTFE. As a result, the mean pore size and the mean pore size and the maximum pore size of the pores formed by the uniaxially stretching process to be in a good range. In addition, by setting the average thickness of the porous membrane of the porous membrane laminate formed after the uniaxially stretching step to from 0.6 μm to 3.5 μm and setting the maximum pore size to 49 nm or less, it is possible to improve the effectiveness and accuracy of the filtration treatment of the porous membrane laminate. Therefore, the method of manufacturing a porous membrane laminate may easily and reliably manufacture a porous membrane laminate excellent in fine particle capturing performance and filtration efficiency.

### OTHER EMBODIMENTS

It should be understood that the embodiments disclosed herein are illustrative in all respects and are not restrictive. The scope of the present invention is not limited to the configurations of the above-described embodiments, but is defined by the claims, and is intended to include meanings equivalent to the claims and all modifications within the scope.

### REFERENCE SIGNS LIST

1 support layer
2 porous membrane
10 porous membrane laminate

1. A porous membrane laminate comprising:
a porous support layer; and
a porous membrane laminated on one surface of the support layer and containing polytetrafluoroethylene as a main component,
wherein the porous membrane is formed of a uniaxially stretched material,
the porous membrane has a mean pore size of 25 nm to 35 nm and a maximum pore size of 49 nm or less, and
the porous membrane has an average thickness of 0.6 μm to 3.5 μm.

2. The porous membrane laminate according to claim 1, having an isopropanol bubble point of 600 kPa or more.

3. The porous membrane laminate according to claim 1, wherein the porous membrane laminate has an area of 623.7 cm² or more in plan view.

4. A filter element comprising the porous membrane laminate claim 1.

5. A method of manufacturing a porous membrane laminate including a porous support layer and a porous membrane laminated on one surface of the support layer, the method comprising:
applying a porous membrane-forming composition containing polytetrafluoroethylene as a main component to a surface of a metal foil;
sintering the porous membrane-forming composition applied in the application;
laminating, on one surface of the support layer, a nonporous membrane formed after the sintering to form a nonporous membrane laminate with the metal foil;
removing the metal foil from the nonporous membrane laminate with the metal foil formed in the lamination;
selecting, among nonporous membrane laminates after the removal, a nonporous membrane laminate having a pressure resistance to a fluorine-based solvent of 101.325 kPa or more; and
uniaxially stretching, at room temperature, the nonporous membrane laminate selected by the selection,
wherein the fluorine-based solvent has a boiling point of 130° C. or lower and a surface tension of 15 mN/m or less, and
a porous membrane of a porous membrane laminate formed after the uniaxial stretching has an average thickness of 0.6 μm to 3.5 μm and a maximum pore size of 49 nm or less.

6. The method of manufacturing a porous membrane laminate according to claim 5, wherein the nonporous membrane of the nonporous membrane laminate selected by the selection includes a defective hole, and the defective hole has a maximum pore size of 600 nm or less.

7. The method of manufacturing a porous membrane laminate according to claim 5, wherein the nonporous membrane of the nonporous membrane laminate selected by the selection does not include a defective hole.
